(19) United States
(12) Patent Application Publication
(10) Pub. No.: US 2015/0112651 A1
(43) Pub. Date: Apr. 23, 2015

(54) Bond Model For Representing Heterogeneous Material In Discrete Element Method

(71) Applicant: Livermore Software Technology Corporation, Livermore, CA (US)

(72) Inventors: Zhidong Han, Livermore, CA (US); Chi-Hsien Wang, Pleasanton, CA (US)

(73) Assignee: Livermore Software Technology Corporation, Livermore, CA (US)

(21) Appl. No.: 14/101,569

(22) Filed: Dec. 10, 2013

Related U.S. Application Data
(60) Provisional application No. 61/892,629, filed on Oct. 18, 2013.

(51) Int. Cl. G06F 17/50

(52) U.S. Cl. CPC G06F 17/5009
USPC 703/2

(57) ABSTRACT

A bond model in DEM is disclosed. The model includes receiving initial location, volume, mass density, bulk shear moduli of discrete particles representing physical domain made of heterogeneous material; assigning an influence range to each discrete particle; establishing a plurality of bonds for connecting the discrete particles, each of the bonds is divided into first and second sub-bonds with the first sub-bond connecting to a first discrete particle and the second sub-bond connecting to a second discrete particle, the said first and second discrete particles are located within the influence range. Each discrete particle is connected to one or more sub-bonds; dividing the volume of each discrete particle into one or more sub-bonds so that one or more sub-bonds are assigned with properties that include length and cross-section area; and obtaining numerically simulated physical phenomena within the physical domain by conducting a time-marching simulation of the bonds with assigned properties.

### FIELD OF THE INVENTION

The present invention generally relates to computer-aided engineering analysis (e.g., discrete element method), more particularly to methods and systems for obtaining numerically simulated physical phenomena of a physical domain made of heterogeneous material in a time-marching simulation based on discrete element method, in particular, using a bond model to facilitate a plurality of heterogeneous discrete particles connected by a number of bonds.

### BACKGROUND OF THE INVENTION

Many modern engineering analyses are performed with the aid of a computer system. One of such computer aided engineering (CAE) analyses is referred to as discrete element method (DEM) or distinct element method, which is generally used for numerically simulating the motion of a large number of discrete particles. With advances in computing power and numerical algorithms for nearest neighbor sorting, it has become possible to numerically simulate millions of discrete particles. Today DEM is becoming widely accepted as an effective method of addressing engineering problems in granular and discontinuous materials, especially in crack propagation, granular flows, powder mechanics, and rock mechanics.

The classic mechanics are based on solving Partial Differential Equations (PDEs) over the domain with the assumption of continuous distribution of mass, including finite element methods, boundary integral methods, meshless methods, and so on. In other disciplines, molecular dynamics (MD) have been used for determining the forces and energy atoms and molecules for simulations spanning nano-level to micro-level, which are not suitable for macro-level simulations.

In contrast, DEM offers a different approach that does not require formulation of PDEs for continuum mechanics. However, there are still drawbacks and/or shortcomings in prior art approaches based on DEM. In one example, only single material (i.e., homogeneous material) is allowed in the physical domain to be simulated. In another, only linear material behavior is allowed.

It would, therefore, be desirable to have improvement in DEM that can be used for simulating heterogeneous material and/or non-linear material behaviors in a time-marching simulation based on DEM.

### BRIEF SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

The present invention discloses systems and methods of providing a bond model in a discrete element method for numerically simulating behaviors of heterogeneous material. According to one aspect of the present invention, the method includes receiving a definition of a plurality of heterogeneous discrete particles representing a physical domain made of heterogeneous material in a computer system having an application module installed thereon. The definition includes initial location, volume, mass density, bulk modulus and shear modulus of each discrete particle; assigning an influence range to establish a domain of influence for each of the discrete particles; establishing bonds for connecting the discrete particles, each of the bonds is divided into first and second sub-bonds with the first sub-bond connecting to a first discrete particle and the second sub-bond connecting to a second discrete particle. The first and the second discrete particles are located within the influence range. As a result, each discrete particle is connected to one or more sub-bonds; dividing, in accordance with a volume division scheme, the volume of each discrete particle into one or more sub-bonds so that sub-bonds are assigned with properties that include a length and a cross-section area; and obtaining numerically simulated physical phenomena within the physical domain by conducting a time-marching simulation, according to discrete element method, of the bonds/sub-bonds with the assigned properties.

According to another aspect, obtaining numerically simulated physical phenomena further includes calculating a displacement gradient rate of each bond using velocities of the connected discrete particles (i.e., first and second discrete particles) and updated orientation and length of the bond obtained from previous solution cycle; calculating angular velocities and strain rates through the displacement gradient rate; converting the angular velocities and the strain rates of each of the bonds to angular velocities and strain rates at each discrete particle in accordance with a response conversion scheme; and calculating stresses and corresponding reaction forces at each discrete particle from the angular velocities and the strain rates for obtaining a new location and velocities of each discrete particle.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIGS. 1A-1B are collectively a flowchart illustrating an exemplary process of providing a bond model in discrete element method for numerically simulating behaviors of heterogeneous material in accordance with one embodiment of the present invention;

FIG. 2 is a two-dimensional view showing an exemplary physical domain represented by a plurality of heterogeneous discrete particles, according to an embodiment of the present invention;

FIGS. 3A-3B are two-dimensional views showing two exemplary domains of influence, according to an embodiment of the present invention;

FIG. 4 is a two-dimensional diagram showing an exemplary configuration of a discrete particle of interest with other connected heterogeneous discrete particles and corresponding bonds, according to an embodiment of the present invention;

FIG. 5 is a diagram showing an exemplary bond with various dimension definitions, according to an embodiment of the present invention;

FIG. 6 is a diagram showing an exemplary three-dimensional discrete particle (i.e., a sphere) in accordance with one embodiment of the present invention;

FIG. 7 is a two-dimensional diagram showing an exemplary configuration of a bond with two sub-bonds having various responses in accordance with one embodiment of the present invention;

FIG. 8 is a two-dimensional diagram showing an exemplary response combination scheme from sub-bonds to a connected discrete particle in accordance with one embodiment of the present invention; and

FIG. 9 is a function diagram showing salient components of a computing system, in which an embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

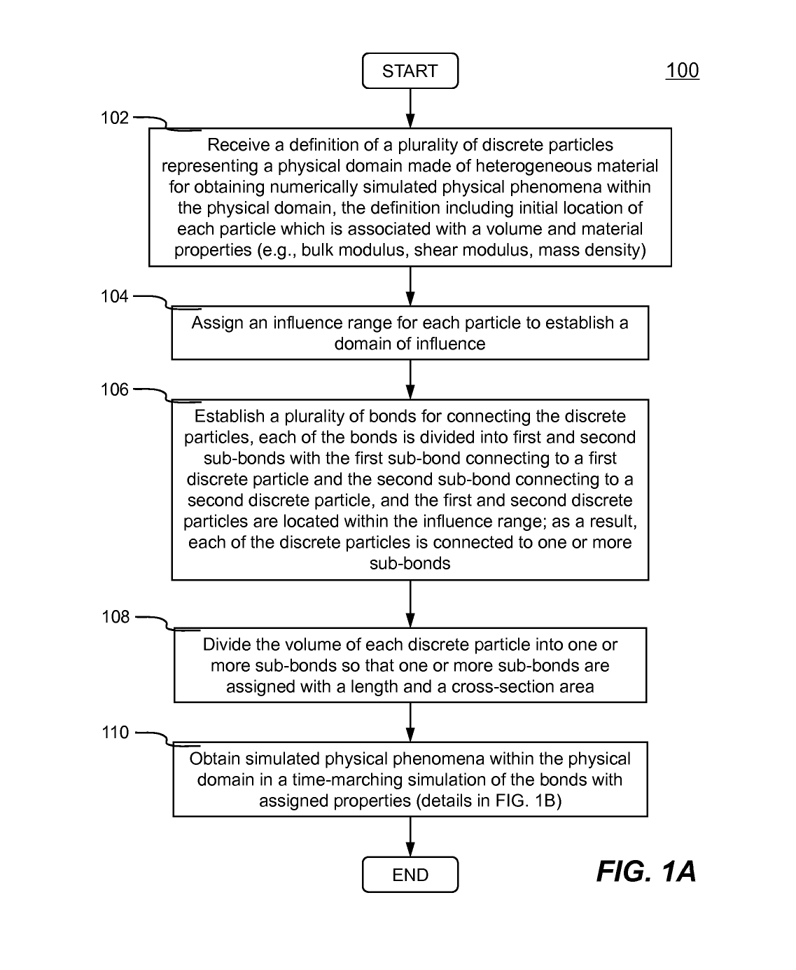

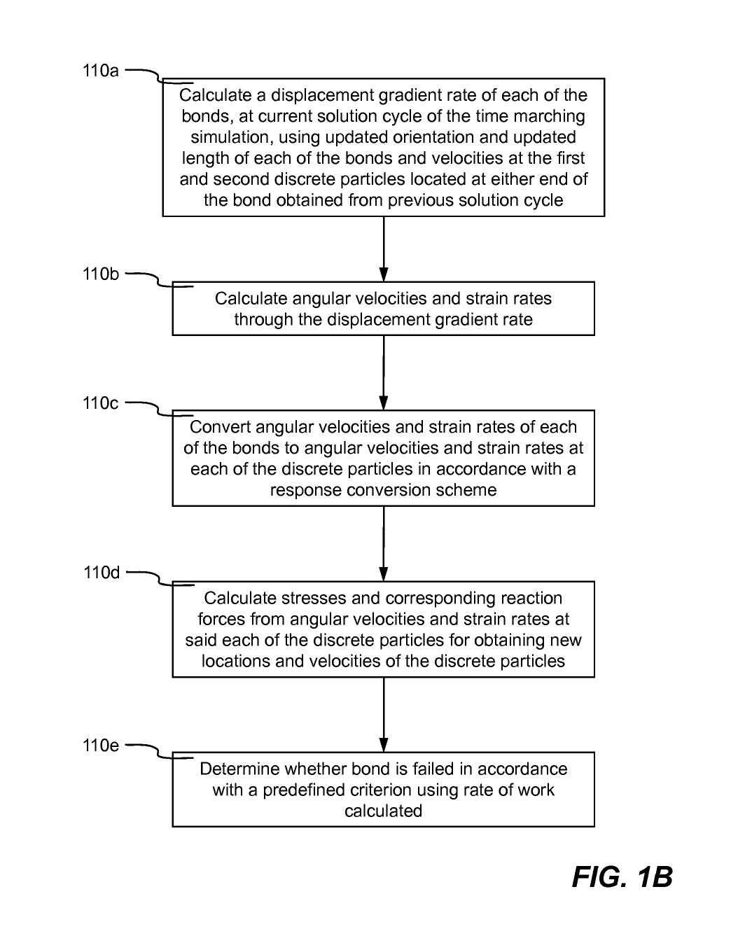

Embodiments of the present invention are discussed herein with reference to FIGS. 1A-9. However, those skilled in the art will readily appreciate that the detailed description given herein with respect to these figures is for explanatory purposes as the invention extends beyond these limited embodiments.

Referring first to FIGS. 1A-1B, it is shown a flowchart illustrating an exemplary process 100 of providing a bond model in discrete element method (DEM) for numerically simulating structural behaviors of heterogeneous material. Process 100 is implemented in software and preferably understood with other figures.

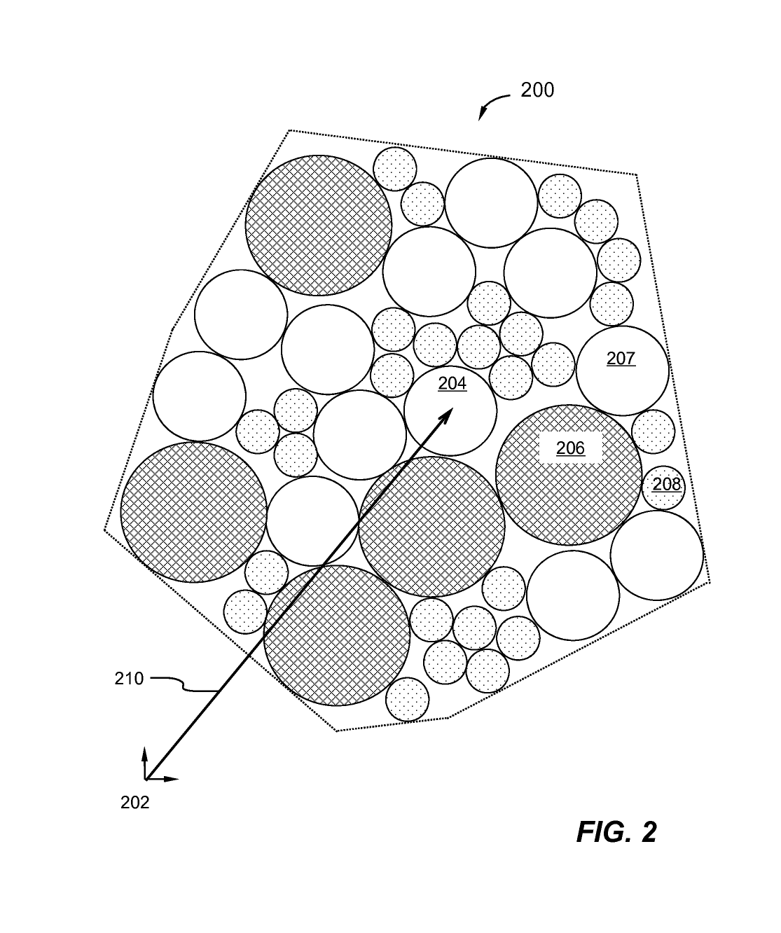

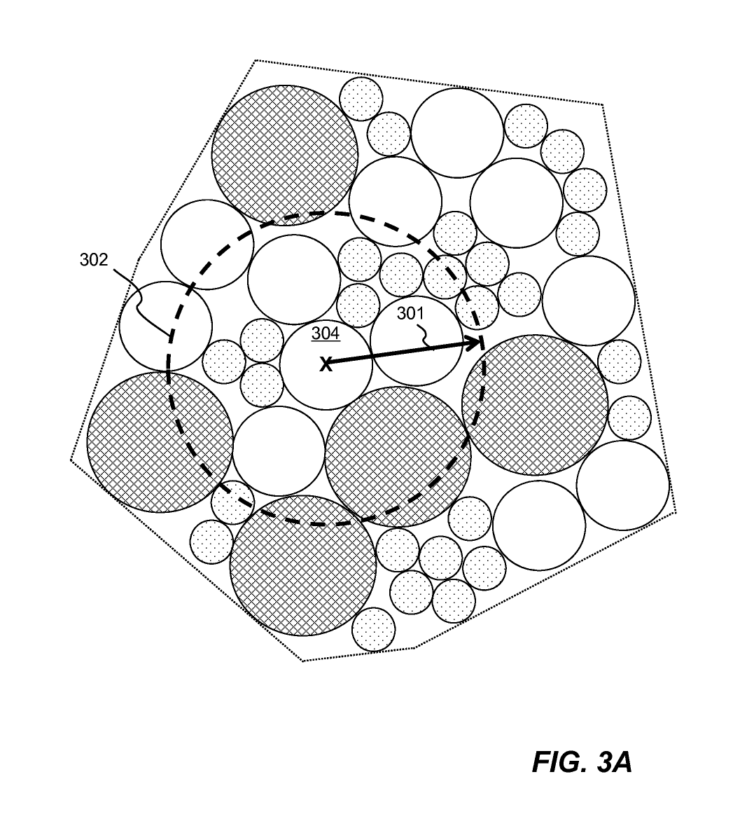

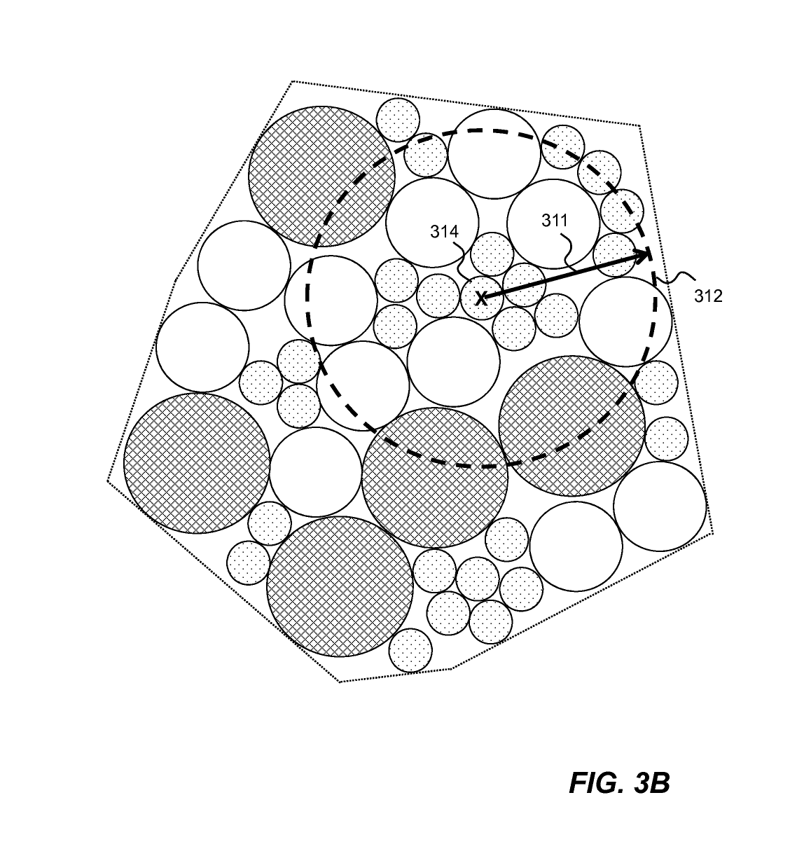

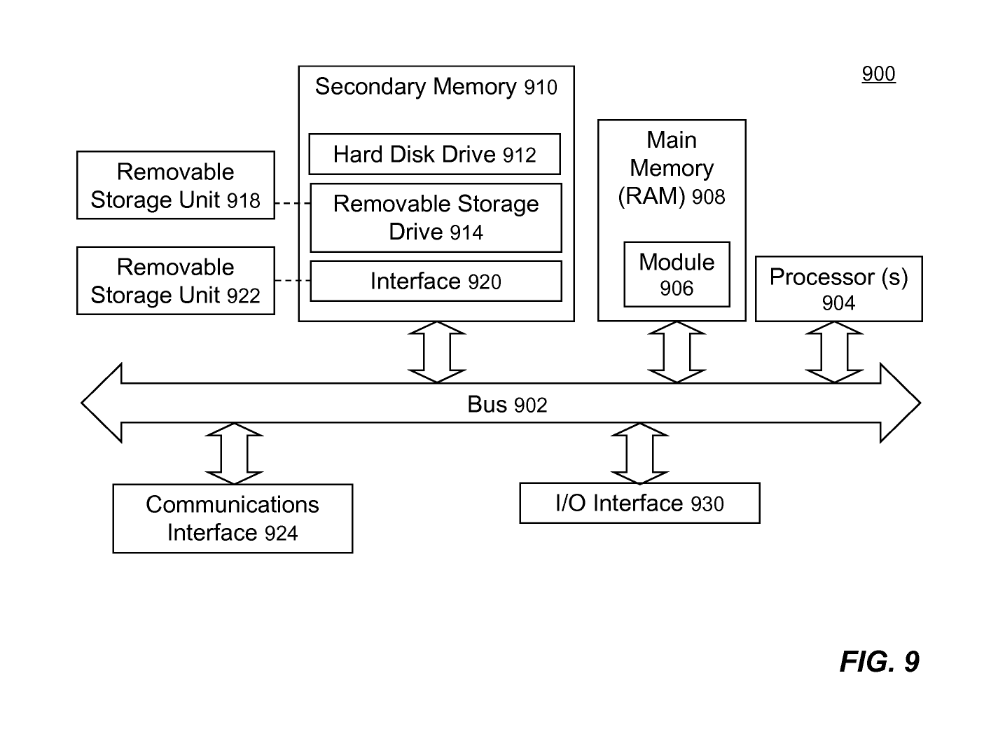

Process 100 starts by receiving, in a computer system (e.g., computer system 900 of FIG. 9), a definition of a plurality of discrete particles that represents a physical domain made of heterogeneous material at step 102. Physical domain can have any size or shape. For example, a two-dimensional view of an exemplary domain 200 is shown in FIG. 2. Each discrete particle is defined by its initial location, volume and material properties (e.g., mass density, bulk modulus and shear modulus). The initial location of a particular discrete particle 204 can be a vector 210 defined in a coordinate system (e.g., coordinate system 202 shown in FIG. 2). Different discrete particles 206, 207, 208 are included in defining the physical domain 200 (i.e., heterogeneous material such as concrete). Next, at step 104, an influence range is assigned to the discrete particle to establish a domain of influence. Exemplary influence ranges are shown in FIGS. 3A-3B. A first influence range 301 is used for establishing a first domain of influence 302 for a first discrete particle 304. A second influence range 311 is used for establishing a second domain of influence 312 for a second discrete particle 314.

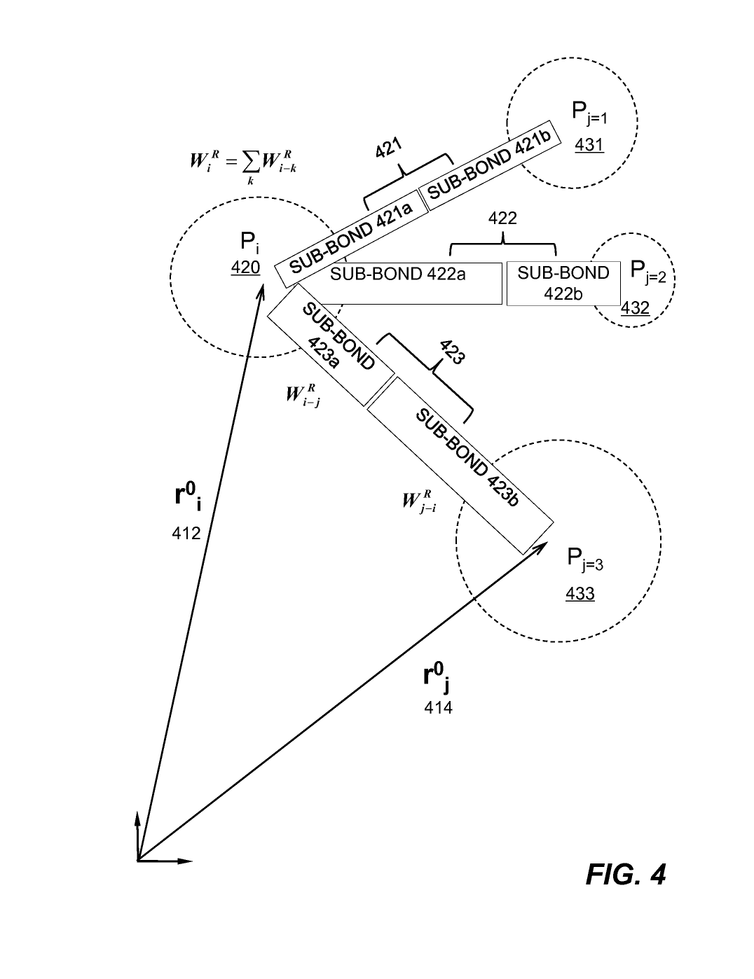

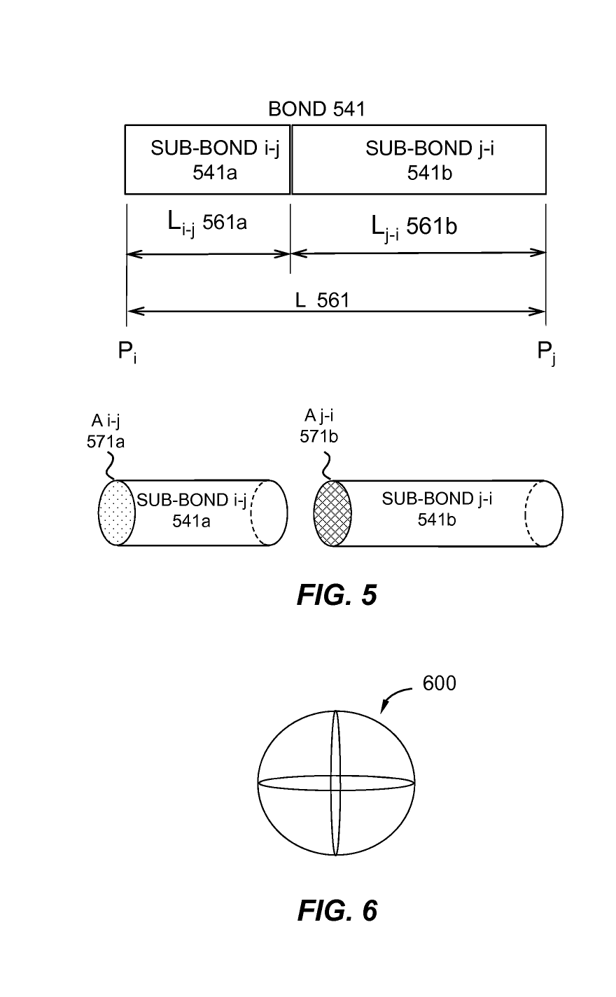

At step 106, a number of bonds are established for connecting the discrete particles. Each bond is divided into two sub-bonds (i.e., first and second sub-bonds). At either end of the bond, first and second sub-bonds are connected to first and second discrete particles, respectively. The first and the second discrete particles are located within the influence range. In other words, a discrete particle of interest is connected to one or more sub-bonds, which are connected to other discrete particles located within the domain of influence of the discrete particle of interest. FIG. 4 is a diagram showing an exemplary configuration of a particular discrete particle Pᵢ 420 connecting to three other discrete particles Pⱼ 431, 432, 433 via respective bonds 421, 422, 423. Each of the bonds 421-423 contains first and second sub-bonds 421a-421b, 422a-422b, 423a-423b. Discrete particle Pᵢ 420 has an initial location/position measured by a vector rᵢ⁰ 412, while discrete particle Pⱼ₌₃ 433 has an initial location by a vector rⱼ⁰ 414. Similarly, discrete particle Pⱼ₌₃ 433 can have one or more sub-bonds connected thereto (only one shown). It is noted that each bond is located between respective centers of the discrete particles connected thereto at either end. For illustration simplicity and clarification, the bonds in FIG. 4 are not drawn to the start and the end at respective centers. FIG. 5 is a diagram showing various definitions of an exemplary bond 541, which is divided into a first sub-bond “SUB-BOND i-j” 541a and a second sub-bond “SUB-BOND j-i” 541b. The length L 561 of the bond 541 is measured between respective centers of particles Pᵢ and Pⱼ. The length of the “SUB-BOND i-j” 541a is denoted as Lᵢ₋ⱼ 561a, while the length of the “SUB-BOND j-i” 541b is denoted as Lⱼ₋ᵢ 561b. Each of the sub-bonds are also illustrated in perspective views to show cross-section area Aᵢ₋ⱼ 571a and Aⱼ₋ᵢ 571b.

Next, at step 108, the volume of each discrete particle is distributed to its connecting sub-bonds based on a volume division scheme based on total influence weight of each discrete particle and respective influence weights of the connecting sub-bonds. As a result, each of the connecting sub-bonds is assigned with properties including cross-section area and length. The volume division scheme is demonstrated below as a set of formulas and preferably understood with FIGS. 4 and 5.
Volumes of discrete particles Pᵢ and Pⱼ Vᵢ, Vⱼ
Initial locations of discrete particles rᵢ⁰, rⱼ⁰
Length of a bond L=∥rⱼ⁰−rᵢ⁰∥
Influence range R
Influence weight of a sub-bond Wᵢ₋ⱼ^{R}=Vⱼ if ∥rⱼ⁰−rᵢ⁰∥≦R (for 2-D domain)
   Wᵢ₋ⱼ^{R}=Vⱼ/L if ∥rⱼ⁰−rᵢ⁰∥≦R (for 3-D domain)
Total influence weight of particles

$${W}_{i}^{R} = {\sum }_{k} {W}_{i - k}^{R} , {W}_{j}^{R} = {\sum }_{k} {W}_{j - k}^{R}$$

Volumes of sub-bonds Vᵢ₋ⱼ=VᵢWᵢ₋ⱼ^{R}/Wᵢ^{R}, Vⱼ₋ᵢ=VⱼWⱼ₋ᵢ^{R}/Wⱼ^{R}
Volume of a bond V_{bond}=Vᵢ₋ⱼ+Vⱼ₋ᵢ
Cross-section area of a bond A=Aᵢ₋ⱼ=Aⱼ₋ᵢ=V_{bond}/L
Lengths of sub-bonds Lᵢ₋ⱼ=Vᵢ₋ⱼ/A, Lⱼ₋ᵢ=Vⱼ₋ᵢ/A

The discrete particles have been shown as two-dimensional circles so far. However, the present invention can be applied to three-dimensional discrete particle (i.e., a sphere 600 shown in FIG. 6).

Referring back to process 100, at step 110, numerically simulated physical phenomena within the physical domain is obtained in a time-marching simulation (based on DEM) of the bonds with assigned properties that include cross-section area and length. The time-marching simulation includes a number of solution cycles in time.

At each solution cycle, a displacement gradient rate is obtained through updated orientation and length of the bond (i.e., updated locations/positions of the discrete particles connected at either end of the bond) and updated velocities of the discrete particles from previous solution cycle at step 110a. Then angular velocities and strain rates (i.e., volumetric and deviatoric strain rates) of each bond are calculated through the displacement gradient rate at step 110b.
Current positions of discrete particles rᵢ, rⱼ
Current length of a bond l=∥rⱼ−rᵢ∥
Current orientation of a bond n=(rⱼ−rᵢ)/l
Velocities of discrete particles vᵢ, vⱼ
Displacement gradient rate of a bond \dot{D}_{•r}=(vⱼ−vᵢ)/l, and \dot{D}_{•s}=\dot{D}_{•t}=0
Angular velocities of a bond \dot{ω}=(\dot{D}−\dot{D}^{T})/2
Strain rate of a bond \dot{ε}=(\dot{D}+\dot{D}^{T})/2
Volumetric strain rate of a bond \dot{ε}^{v}=\dot{ε}:I
Deviatoric strain rate of a bond \dot{ε}′=\dot{ε}−(\dot{ε}^{v}/3)I

At step 110c, the angular velocities and strain rates of the bond are converted to respective sub-bonds using formulas listed below:
Bulk modulus of the particles Kᵢ, Kⱼ
Shear modulus of the particles Gᵢ, Gⱼ
Angular velocities in sub-bonds

$${\dot{ω}}_{i - j} = \frac{{G}_{j}}{{G}_{i} + {G}_{j}} \dot{ω} and {\dot{ω}}_{j - i} = \frac{{G}_{i}}{{G}_{i} + {G}_{j}} \dot{ω}$$

Volumetric strain rates in sub-bonds

$${\dot{ɛ}}_{i - j}^{v} = \frac{{K}_{j}}{{K}_{i} + {K}_{j}} {\dot{ɛ}}^{v} and {\dot{ɛ}}_{j - i}^{v} = \frac{{K}_{i}}{{K}_{i} + {K}_{j}} {\dot{ɛ}}^{v}$$

Deviatoric strain rates in sub-bonds

$${\dot{ɛ}}_{i - j}^{′} = \frac{{G}_{j}}{{G}_{i} + {G}_{j}} {\dot{ɛ}}^{′} and {\dot{ɛ}}_{j - i}^{′} = \frac{{G}_{i}}{{G}_{i} + {G}_{j}} {\dot{ɛ}}^{′}$$

Then the angular velocities and strain rates of each discrete particle are derived using the following formula in a response combination scheme:
Angular Velocities

$${\dot{ω}}_{i} = {\sum }_{k} ( {\dot{ω}}_{i - k} {W}_{i - k}^{R} ) / {W}_{i}^{R}$$

Volumetric strain rate

$${\dot{ɛ}}_{i}^{v} = {\sum }_{k} ( {\dot{ɛ}}_{i - k}^{v} {W}_{i - k}^{R} ) / {W}_{i}^{R}$$

Deviatoric strain rate

$${\dot{ɛ}}_{i}^{′} = {\sum }_{k} ( {\dot{ɛ}}_{i - k}^{′} {W}_{i - k}^{R} ) / {W}_{i}^{R}$$

Next, at step 110d, stresses σᵢ, σⱼ are calculated from the angular velocities and strain rates of each discrete particle based on the traditional material constitutional model. Thereafter the corresponding reaction forces fⱼ₋ᵢ within the bond are determined for obtaining new current locations/positions and velocities for the next solution cycle.
Stresses in a discrete particle σᵢ∫C(Δt, \dot{ε}ᵢ^{v}, \dot{ε}ᵢ′, \dot{ω}ᵢ, σᵢ, . . . )dt
Reaction forces in a bond

$${f}_{j - i} = - {f}_{i - j} = \frac{A}{2} ( {σ}_{i} + {σ}_{j} ) \cdot n$$

Finally, at step 110e, any failure of a bond is determined by comparing calculated fracture energy release rate to a predefined critical value G_{c}, which is determined from the fracture properties Gᵢ_{_{c}} and Gⱼ_{_{c}} of particles Pᵢ and Pⱼ, as well as the interface Gᵢⱼ_{_{c}} between Pᵢ and Pⱼ. The calculation of fracture energy release rate is based on the following formulas:
Rate of work in a bond \dot{w}=\dot{w}ᵢ₋ⱼ+\dot{w}ⱼ₋ᵢ=fⱼ₋ᵢ·(vⱼ−vᵢ)
Bond failure criteria

$$\frac{1}{A} \int \dot{w} d t \geq {G}_{c}$$

Predefined fracture energy release rate G_{c}=G_{c}(Gᵢ_{_{c}}, Gⱼ_{_{c}}, Gᵢⱼ_{_{c}})

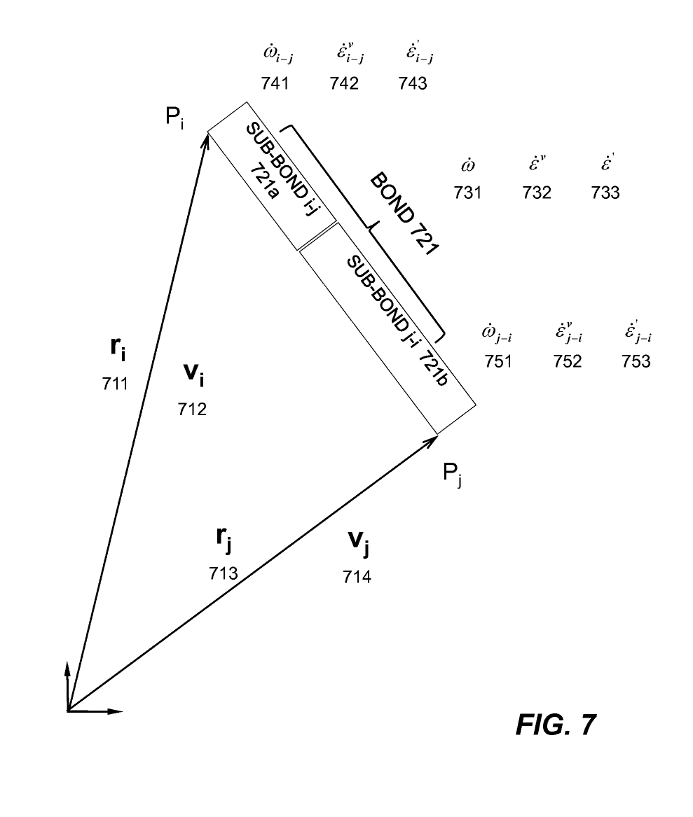

FIG. 7 is a diagram showing a configuration of an exemplary bond 721 having two sub-bonds “SUB-BOND i-j” 721a and “SUB-BOND j-i” 721b having various responses. The bond 721 connects two discrete particles Pᵢ and Pⱼ. The responses include angular velocities \dot{ω} 731, volumetric strain rate \dot{ε}^{v} 732 and deviatoric strain rate \dot{ε} 733 of the bond 721 derived from updated position/location rᵢ 711 and velocities vᵢ 712 of discrete particle Pᵢ and updated position/location rⱼ 713 and velocities vⱼ 714 of discrete particle Pⱼ. The responses of the bond 721 are then converted to those of each of the two sub-bonds, which are angular velocities \dot{ω}ᵢ₋ⱼ 741, volumetric strain \dot{ε}ᵢ₋ⱼ^{v} 742 and deviatoric strain rate \dot{ε}ᵢ₋ⱼ 743 for the first sub-bond “SUB-BOND i-j” 721a, and angular velocities \dot{ω}ⱼ₋ᵢ 751, volumetric strain rate \dot{ε}ⱼ₋ᵢ^{v} 752 and deviatoric strain rate \dot{ε}ⱼ₋ᵢ 753 for the second sub-bond “SUB-BOND i-i” 721b.

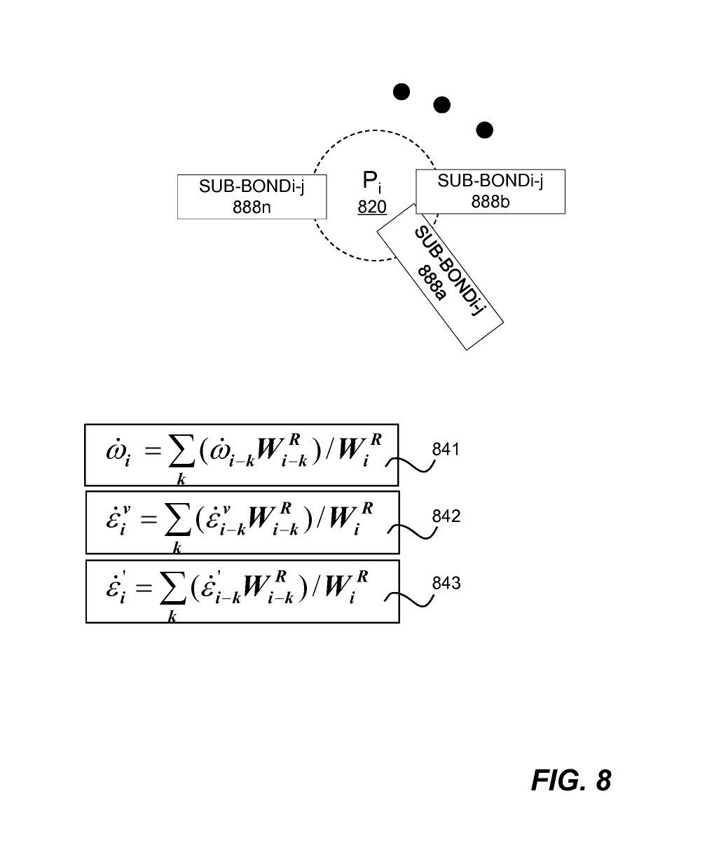

FIG. 8 is a diagram showing an exemplary response combination scheme from one or more sub-bonds 888a-888n to a discrete particle Pᵢ 820. The responses (i.e., angular velocities \dot{ω}ᵢ 841, volumetric strain rate \dot{ε}ᵢ^{v} 842 and deviatoric strain rate \dot{ε}ᵢ 843) at discrete particle Pᵢ 820 is a weighted sum of those responses of all of the sub-bonds 888a-888n connected thereto.

According to one aspect, the present invention is directed towards one or more computer systems capable of carrying out the functionality described herein. An example of a computer system 900 is shown in FIG. 9. The computer system 900 includes one or more processors, such as processor 904. The processor 904 is connected to a computer system internal communication bus 902. Various software embodiments are described in terms of this exemplary computer system. After reading this description, it will become apparent to a person skilled in the relevant art(s) how to implement the invention using other computer systems and/or computer architectures.

Computer system 900 also includes a main memory 908, preferably random access memory (RAM), and may also include a secondary memory 910. The secondary memory 910 may include, for example, one or more hard disk drives 912 and/or one or more removable storage drives 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc. which is read by and written to by removable storage drive 914. As will be appreciated, the removable storage unit 918 includes a computer usable storage medium having stored therein computer software and/or data.

In alternative embodiments, secondary memory 1110 may include other similar means for allowing computer programs or other instructions to be loaded into computer system 900. Such means may include, for example, a removable storage unit 922 and an interface 920. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 922 and interfaces 920 which allow software and data to be transferred from the removable storage unit 922 to computer system 900. In general, Computer system 900 is controlled and coordinated by operating system (OS) software, which performs tasks such as process scheduling, memory management, networking and I/O services.

There may also be a communications interface 924 connecting to the bus 902. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928 which may be electronic, electromagnetic, optical, or other signals capable of being received by communications interface 924. The computer 900 communicates with other computing devices over a data network based on a special set of rules (i.e., a protocol). One of the common protocols is TCP/IP (Transmission Control Protocol/Internet Protocol) commonly used in the Internet. In general, the communication interface 924 manages the assembling of a data file into smaller packets that are transmitted over the data network or reassembles received packets into the original data file. In addition, the communication interface 924 handles the address part of each packet so that it gets to the right destination or intercepts packets destined for the computer 900.In this document, the terms “computer program medium” and “computer usable medium” are used to generally refer to media such as removable storage drive 914, and/or a hard disk installed in hard disk drive 912. These computer program products are means for providing software to computer system 900. The invention is directed to such computer program products.

The computer system 900 may also include an input/output (I/O) interface 930, which provides the computer system 900 to access monitor, keyboard, mouse, printer, scanner, plotter, and alike.

Computer programs (also called computer control logic) are stored as application modules 906 in main memory 908 and/or secondary memory 910. Computer programs may also be received via communications interface 924. Such computer programs, when executed, enable the computer system 900 to perform the features of the present invention as discussed herein. In particular, the computer programs, when executed, enable the processor 904 to perform features of the present invention. Accordingly, such computer programs represent controllers of the computer system 900.

In an embodiment where the invention is implemented using software, the software may be stored in a computer program product and loaded into computer system 900 using removable storage drive 914, hard drive 912, or communications interface 924. The application module 906, when executed by the processor 904, causes the processor 904 to perform the functions of the invention as described herein.

The main memory 908 may be loaded with one or more application modules 906 (e.g., discrete element method) that can be executed by one or more processors 904 with or without a user input through the I/O interface 930 to achieve desired tasks. In operation, when at least one processor 904 executes one of the application modules 906, the results are computed and stored in the secondary memory 910 (i.e., hard disk drive 912). The result and/or status of the finite element analysis (e.g., crack propagation) is reported to the user via the I/O interface 930 either in a text or in a graphical representation to a monitor coupled to the computer.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. Whereas the discrete particles have been generally shown in two-dimension for illustration simplicity, the present invention can be applied to a three-dimensional particle, for example, a sphere. Further, whereas physical domain has been shown as in two-dimensional views, physical domain can be a three-dimensional space. In summary, the scope of the invention should not be restricted to the specific exemplary embodiments disclosed herein, and all modifications that are readily suggested to those of ordinary skill in the art should be included within the spirit and purview of this application and scope of the appended claims

1. A method of providing a bond model in discrete element method for numerically simulating behaviors of heterogeneous material, said method comprising:
receiving a definition of a plurality of discrete particles representing a physical domain made of heterogeneous material in a computer system having an application module installed thereon, the definition including initial location, volume, mass density, bulk modulus and shear modulus of each of the discrete particles;
assigning an influence range to establish a domain of influence for said each of the discrete particles;
establishing a plurality of bonds for connecting the discrete particles, wherein each of the bonds is divided into first and second sub-bonds with the first sub-bond connecting to a first one of the discrete particles and the second sub-bond connecting to a second one of the discrete particles, and said first one and said second one of the discrete particles are located within the influence range, as a result, said each of the discrete particles is connected to one or more sub-bonds;
dividing, in accordance with a volume division scheme, the volume of said each of the discrete particles into said one or more sub-bonds so that said one or more sub-bonds are assigned with properties that include a length and a cross-section area; and
obtaining numerically simulated physical phenomena within the physical domain by conducting a time-marching simulation, based on discrete element method, of the plurality of bonds with said assigned properties using the application module.

2. The method of claim 1, wherein said obtaining numerically simulated physical phenomena further comprising:
calculating a displacement gradient rate of said each of the bonds, at current solution cycle of the time marching simulation, using updated orientation and updated length of said each of the bonds and velocities at said first one and said second one of the discrete particles obtained from previous solution cycle;
calculating angular velocities and strain rates through the displacement gradient rate;
converting said angular velocities and said strain rates of said each of the bonds to angular velocities and strain rates at said each of the discrete particles in accordance with a response conversion scheme; and
calculating stresses and corresponding reaction forces from the angular velocities and the strain rates at said each of the discrete particles for obtaining a new location and velocities of said each of the discrete particles.

3. The method of claim 2, wherein said volume division scheme comprises determining a total influence weight of said each of the discrete particles and respective individual influence weights for said one or more sub-bonds based on said respective initial locations and volumes of the discrete particles.

4. The method of claim 2, wherein the updated orientation and the updated length are determined from updated locations of said first one and said second one of the discrete particles.

5. The method of claim 3, wherein the strain rates include volumetric strain rate and deviatoric strain rate.

6. The method of claim 5, wherein said response conversion scheme includes using respective bulk moduli and shear moduli of said first one and said second one of the discrete particles to divide said angular velocities and said strain rates of said each of the bonds into said first and said second sub-bonds.

7. The method of claim 6, wherein said response conversion scheme further includes combining said angular velocities and said strain rates of said one or more sub-bonds into said each of the discrete particles using a weighted summation scheme using the total influence weight and said respective individual influence weights.

8. The method of claim 2, further comprising determining whether said each of the bonds is failed using a rate of work derived from the reaction forces and respective said current velocities at said first one and said second one of the discrete particles, and a predefined fracture energy release rate.

9. The method of claim 1, wherein the heterogeneous material comprises concrete.

10. A system for providing a bond model in discrete element method for numerically simulating behaviors of heterogeneous material, the system comprising:
a main memory for storing computer readable code for an application module;
at least one processor coupled to the main memory, said at least one processor executing the computer readable code in the main memory to cause the application module to perform operations by a method of:
receiving a definition of a plurality of discrete particles representing a physical domain made of heterogeneous material, the definition including initial location, volume, mass density, bulk modulus and shear modulus of each of the discrete particles;
assigning an influence range to establish a domain of influence for said each of the discrete particles;
establishing a plurality of bonds for connecting the discrete particles, wherein each of the bonds is divided into first and second sub-bonds with the first sub-bond connecting to a first one of the discrete particles and the second sub-bond connecting to a second one of the discrete particles, and said first one and said second one of the discrete particles are located within the influence range, as a result, said each of the discrete particles is connected to one or more sub-bonds;
dividing, in accordance with a volume division scheme, the volume of said each of the discrete particles into said one or more sub-bonds so that said one or more sub-bonds are assigned with properties that include a length and a cross-section area; and
obtaining numerically simulated physical phenomena within the physical domain by conducting a time-marching simulation, based on discrete element method, of the plurality of bonds with said assigned properties using the application module.

11. The system of claim 10, wherein said obtaining numerically simulated physical phenomena further comprising:
calculating a displacement gradient rate of said each of the bonds, at current solution cycle of the time marching simulation, using updated orientation and updated length of said each of the bonds and velocities at said first one and said second one of the discrete particles obtained from previous solution cycle;
calculating angular velocities and strain rates through the displacement gradient rate;
converting said angular velocities and said strain rates of said each of the bonds to angular velocities and strain rates at said each of the discrete particles in accordance with a response conversion scheme; and
calculating stresses and corresponding reaction forces from the angular velocities and the strain rates at said each of the discrete particles for obtaining a new location and velocities of said each of the discrete particles.

12. The system of claim 11, wherein said volume division scheme comprises determining a total influence weight of said each of the discrete particles and respective individual influence weights for said one or more sub-bonds based on said respective initial locations and volumes of the discrete particles.

13. The system of claim 12, wherein said response conversion scheme includes using respective bulk moduli and shear moduli of said first one and said second one of the discrete particles to divide said angular velocities and said strain rates of said each of the bonds into said first and said second sub-bonds.

14. The system of claim 13, wherein said response conversion scheme further includes combining said angular velocities and said strain rates of said one or more sub-bonds into said each of the discrete particles using a weighted summation scheme using the total influence weight and said respective individual influence weights.

15. The system of claim 10, wherein the heterogeneous material comprises concrete.

16. A non-transitory computer recordable storage medium containing computer instructions for providing a bond model in discrete element method for numerically simulating behaviors of heterogeneous material, said computer instructions when executed on a computer system cause the computer system to perform the steps of:
receiving a definition of a plurality of discrete particles representing a physical domain made of heterogeneous material in a computer system having an application module installed thereon, the definition including initial location, volume, mass density, bulk modulus and shear modulus of each of the discrete particles;
assigning an influence range to establish a domain of influence for said each of the discrete particles;
establishing a plurality of bonds for connecting the discrete particles, wherein each of the bonds is divided into first and second sub-bonds with the first sub-bond connecting to a first one of the discrete particles and the second sub-bond connecting to a second one of the discrete particles, and said first one and said second one of the discrete particles are located within the influence range, as a result, said each of the discrete particles is connected to one or more sub-bonds;
dividing, in accordance with a volume division scheme, the volume of said each of the discrete particles into said one or more sub-bonds so that said one or more sub-bonds are assigned with properties that include a length and a cross-section area; and
obtaining numerically simulated physical phenomena within the physical domain by conducting a time-marching simulation, based on discrete element method, of the plurality of bonds with said assigned properties using the application module.

17. The non-transitory computer recordable storage medium of claim 16, wherein said obtaining numerically simulated physical phenomena further comprising:
calculating a displacement gradient rate of said each of the bonds, at current solution cycle of the time marching simulation, using updated orientation and updated length of said each of the bonds and velocities at said first one and said second one of the discrete particles obtained from previous solution cycle;
calculating angular velocities and strain rates through the displacement gradient rate;
converting said angular velocities and said strain rates of said each of the bonds to angular velocities and strain rates at said each of the discrete particles in accordance with a response conversion scheme; and
calculating stresses and corresponding reaction forces from the angular velocities and the strain rates at said each of the discrete particles for obtaining a new location and velocities of said each of the discrete particles.

18. The non-transitory computer recordable storage medium of claim 17, wherein said volume division scheme comprises determining a total influence weight of said each of the discrete particles and respective individual influence weights for said one or more sub-bonds based on said respective initial locations and volumes of the discrete particles.

19. The non-transitory computer recordable storage medium of claim 18, wherein said response conversion scheme includes using respective bulk moduli and shear moduli of said first one and said second one of the discrete particles to divide said angular velocities and said strain rates of said each of the bonds into said first and said second sub-bonds.

20. The non-transitory computer recordable storage medium of claim 19, wherein said response conversion scheme further includes combining said angular velocities and said strain rates of said one or more sub-bonds into said each of the discrete particles using a weighted summation scheme using the total influence weight and said respective individual influence weights.
